(19) United States
(12) Patent Application Publication
(10) Pub. No.: US 2025/0298571 A1
(43) Pub. Date: Sep. 25, 2025

(54) VIRTUAL THREE-DIMENSIONAL SPACE SHARING SYSTEM, VIRTUAL THREE-DIMENSIONAL SPACE SHARING METHOD, AND VIRTUAL THREE-DIMENSIONAL SPACE SHARING SERVER

(71) Applicant: Hitachi, Ltd., Tokyo (JP)

(72) Inventors: Yusuke NAKAMURA, Tokyo (JP); Naohito IKEDA, Tokyo (JP); Ryota KAWAMATA, Tokyo (JP); Keiichi MITANI, Tokyo (JP); Yuya OGI, Tokyo (JP); Takashi NUMATA, Tokyo (JP)

(21) Appl. No.: 18/860,850

(22) PCT Filed: Jan. 24, 2023
(86) PCT No.: PCT/JP2023/002119

§ 371 Date: Oct. 28, 2024

(30) Foreign Application Priority Data
Sep. 29, 2022 (JP) 2022-156516

(51) Int. Cl. G06F 3/14; G06F 3/01; G06T 19/00; G06V 20/40; G06V 20/52; G06V 40/20

(52) U.S. Cl. CPC G06F 3/1454; G06F 3/011; G06T 19/00; G06V 20/40; G06V 20/52; G06V 40/20; G06T 2219/024

(57) ABSTRACT

A virtual three-dimensional space sharing system includes a first display device that a first user can visually recognize at a first location, a first sensor that observes an object and the first user at the first location, a second sensor that observes the movement of a second user at a second location different from the first location, and a server that collects data from the first sensor and the second sensor, and the server maps the object and the first user observed by the first sensor and the second user observed by the second sensor to a virtual three-dimensional space, and transmits information regarding the movement and the position of the second user mapped to the virtual three-dimensional space to the first display device.

### Incorporation by Reference

This application claims priority to Japanese Patent Application No. 2022-156516, filed on Sep. 29, 2022, the content of which is incorporated herein by reference.

### TECHNICAL FIELD

The present invention relates to a virtual three-dimensional space sharing system.

### BACKGROUND ART

There is a situation in which a plurality of persons in remote places want to share information. For example, in a case where facilities at a site fail, a skilled maintenance worker may go to a place where the site is located and give guidance on maintenance. In order for a skilled maintenance worker to go to a remote place where the site is located, schedule adjustment is required, which delays repairs of the failure and incurs travel costs. Alternatively, in a case of receiving guidance from a skilled maintenance worker with use of a remote conference system, there is a problem that it is difficult to give accurate guidance by oral or image sharing.

Meanwhile, the following are pieces of prior art as systems for recognizing a work situation with use of a virtual space. According to a situation recognizing support system described in Patent Document 1 (JP-2021-47610-A), when a worker wearing an MR-HMD observes a workpiece in a space as a construction site from various positions in various directions, the three-dimensional shape of the workpiece is measured by a terminal device from an image captured by the MR-HMD. The terminal device receives three-dimensional shape data representing the three-dimensional shape of the workpiece, generates an image in which input fields of inspection results related to the construction of the workpiece are superimposed on the three-dimensional shape of the workpiece seen from an inspector in a virtual space having a common space and coordinate system, the three-dimensional shape being determined on the basis of the three-dimensional shape data and the position and posture of a VR-HMD worn by the inspector, and displays the image on the VR-HMD. The inspector inputs, into the input fields, the results of the inspection conducted while looking at the three-dimensional shape of the workpiece displayed on the VR-HMD.

In addition, according to a finished form confirmation system described in Patent Document 2 (JP-2006-349578-A), a three-dimensional laser scanner is used to scan the surface of a finished form, and three-dimensional point group data regarding the surface of the finished form is synthesized in a virtual space constructed in a computer. Next, information related to a core is synthesized in the virtual space as defined in a work place, and a virtual plane perpendicular thereto is constructed and moved to set a virtual skeleton surface. Then, the surface of the finished form or the like is displayed on a screen by changing the display mode between the front side or the back side of the set virtual skeleton surface.

### SUMMARY OF THE INVENTION

### Problem to be Solved by the Invention

In the above-described situation recognizing support system described in Patent Document 1 and the finished form confirmation system described in Patent Document 2, there is no mechanism for sharing a real-time situation at a site and motions of a plurality of persons at a remote place in real-time, and there is a problem that it is difficult to give appropriate guidance to the site from the remote place.

An object of the present invention is to share a real-time situation at a site and motions of a plurality of persons at a remote place in real-time.

### Means for Solving the Problem

A representative example of the invention disclosed in the present application is as follows. That is, a virtual three-dimensional space sharing system includes a first display device that a first user can visually recognize at a first location, a first sensor that observes an object which is a dynamic object at least one of a shape and a position of which is changed and the first user at the first location, a second sensor that observes the movement of a second user at a second location different from the first location, and a server that collects data from the first sensor and the second sensor, and the server maps the object and the first user observed by the first sensor and the second user observed by the second sensor to a virtual three-dimensional space, and transmits information regarding the movement and the position of the second user relative to the object which is the dynamic object, the second user being mapped to the virtual three-dimensional space, to the first display device.

### Advantage of the Invention

According to one aspect of the present invention, it is possible to share a real-time situation at a site and motions of a plurality of persons at a remote place in real-time. Problems, configurations, and effects other than those described above will be clarified by the following description of the embodiment.

### BRIEF DESCRIPTION OF THE DRAWINGS

FIG. 1 is a diagram for depicting a configuration of an information sharing system according to an embodiment of the present invention.

FIG. 2 is a block diagram for depicting a physical configuration of a computer provided in the information sharing system of the present embodiment.

FIG. 3 is a logic block diagram of the information sharing system of the present embodiment.

FIG. 4 is a diagram for depicting details of site-side sensing processing of the present embodiment.

FIG. 5 is a diagram for depicting a configuration example of a database of the present embodiment.

FIG. 6 is a diagram for depicting an example of a video displayed on MR glasses of the present embodiment.

FIG. 7 is a diagram for depicting an example of a bird's-eye view image displayed on an administrator terminal of the present embodiment.

### MODE FOR CARRYING OUT THE INVENTION

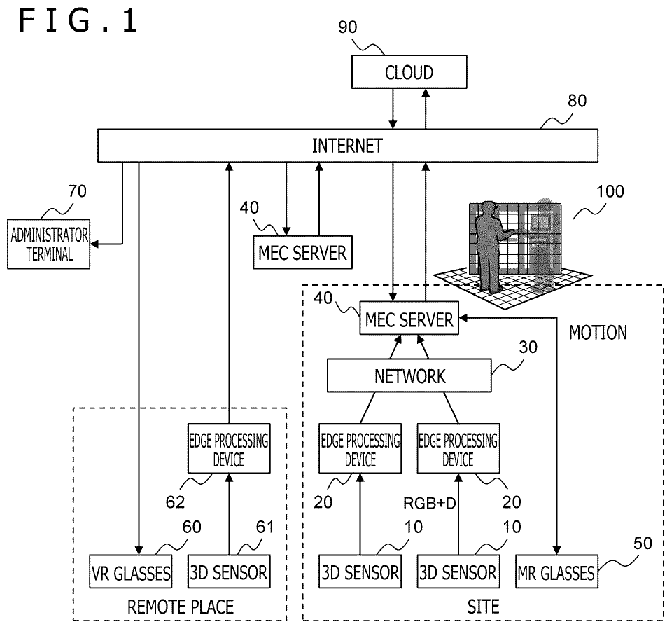

FIG. 1 is a diagram for depicting a configuration of an information sharing system according to an embodiment of the present invention.

The information sharing system of the present embodiment has a plurality of three-dimensional sensors 10, edge processing devices 20 connected to the three-dimensional sensors 10, an MEC server 40 for processing the observation result obtained by the three-dimensional sensors 10, a network 30 for connecting the edge processing devices 20 to the MEC server 40, MR glasses 50, VR glasses 60, a three-dimensional sensor 61 for observing a wearer of the VR glasses 60, and an edge processing device 62 connected to the three-dimensional sensor 61. The information sharing system may have an administrator terminal 70.

The three-dimensional sensor 10 is a sensor for observing a situation of a site to be shared in a virtual three-dimensional space (metaverse space) 100. It is preferable that the three-dimensional sensor 10 be capable of acquiring three-dimensional point group data, and, for example, a TOF camera for outputting an image with a distance in which a distance D for each pixel is added to RGB data can be used. It is preferable that the plurality of three-dimensional sensors 10 be provided to cover a wide range of the site including the working range of a worker and be installed such that the observation ranges of the respective three-dimensional sensors 10 overlap with each other. The three-dimensional sensor 10 observes, as objects, static objects whose shapes and positions do not change, such as facilities installed at the site or structures in a room, and dynamic objects whose shapes and positions change, such as vehicles, construction machines, robots, workers, tools, and work objects. The three-dimensional sensor 10 observes a situation of the worker (for example, the movement and the position of a remote person).

The edge processing device 20 is a computer that generates three-dimensional information including a plurality of pieces of three-dimensional model data and a skeleton model of a person from the point group data acquired by the three-dimensional sensor 10. When the edge processing device 20 generates the three-dimensional information from the point group data, the amount of communication between the edge processing device 20 and the MEC server 40 can be reduced, and the congestion of the network 30 can be suppressed. It should be noted that, in a case where there is no problem with the bandwidth of the network 30, the three-dimensional information may be generated after the point group data is transmitted as it is to the MEC server 40.

The MEC server 40 is a computer for realizing edge computing provided in the network 30, and generates the virtual three-dimensional space 100 from the three-dimensional information collected from one or more edge processing devices 20 in the present embodiment.

The network 30 is a wireless network suitable for data communication that connects the edge processing device 20 and the MEC server 40 to each other, and can use, for example, a high-speed and low-delay 5G network. It should be noted that, in a case where the edge processing device 20 is fixedly installed, a wired network may be used.

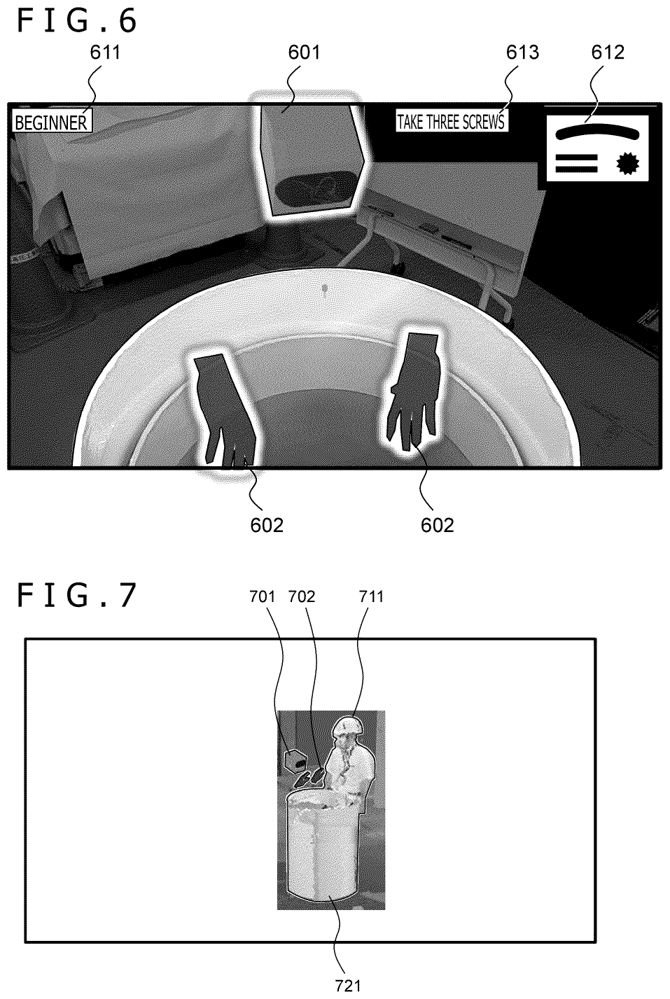

It is preferable that the MR glasses 50 be display devices that can be visually recognized by a worker at the site and be mounted on the head of the worker in order to share the virtual three-dimensional space 100. The MR glasses 50 have a processor for executing programs, a memory for storing programs and data, a network interface for communicating with the MEC server 40, and a display for displaying an image (to be described later with reference to FIG. 6) transmitted from the MEC server 40. It is preferable that the display be of a transmissive type and that the wearer can visually recognize, through the display, the surrounding area in such a manner that the video transmitted from the MEC server 40 is superimposed on a video of the surrounding area. In addition, the MR glasses 50 may have a camera for capturing the front of the wearer, and may transmit a video captured by the camera to the MEC server 40. In addition, the MR glasses 50 may display the video captured by the camera that captures the front of the wearer, in such a manner that the video transmitted from the MEC server 40 is superimposed on the video of the front of the wearer. In addition, the MR glasses 50 may have a camera for capturing the eyes of the wearer, and may detect the direction of the visual line of the wearer from a video captured by the camera. In addition, the MR glasses 50 may have a microphone that detects the sound the wearer is hearing.

In addition, the worker at the site may wear a wearable sensor (for example, a tactile glove). The tactile glove detects the tactile sense of the worker and transmits it to the MEC server 40. In addition, the wearable sensor may detect the movements of the hands and fingers of the worker, may generate a skeleton model of the worker from the movements of the hands and fingers detected by the wearable sensor, and may detect the action of the worker.

It is preferable that the VR glasses 60 be display devices that can be visually recognized by a person (who is hereinafter referred to as a remote person and is, for example, a skilled person) who is at a remote place away from the site and that the VR glasses 60 be mounted on the head of the worker in order to share the virtual three-dimensional space 100. The VR glasses 60 have a processor for executing programs, a memory for storing programs and data, a network interface for communicating with the MEC server 40, and a display for displaying an image (to be described later with reference to FIG. 6) transmitted from the MEC server 40. In addition, the VR glasses 60 may have a camera for capturing the front of the wearer, and may transmit a video captured by the camera to the MEC server 40. In a case where the VR glasses 60 are provided outside the network where the MEC server 40 is provided, it is preferable that the VR glasses 60 and the MEC server 40 be connected to each other via a public network such as the Internet 80 or another dedicated network. The VR glasses 60 receive motion data including the movement and the position of the worker who is at the site, the movement and the position being represented by the skeleton model, from the MEC server 40, and display the virtual three-dimensional space 100 including an avatar of the worker who is at the site. Information regarding the virtual three-dimensional space 100 received by the VR glasses 60 from the MEC server 40 includes information regarding the object observed by the three-dimensional sensor 10, in addition to the avatar of the worker.

The three-dimensional sensor 61 is a sensor for observing a situation of the remote person (for example, the movement and the position of the remote person) wearing the VR glasses 60, which situation is to be shared in the virtual three-dimensional space 100. As with the three-dimensional sensor 10, it is preferable that the three-dimensional sensor 61 be capable of acquiring the three-dimensional point group data, and, for example, a TOF camera for outputting an image with a distance in which a distance D for each pixel is added to RGB data can be used. The remote person may wear the wearable sensor that detects the movements of the hands and fingers. The wearable sensor detects the movements of the hands and fingers of the remote person and transmits them to the MEC server 40. The MEC server 40 may generate a skeleton model of the worker from the movements of the hands and fingers detected by the wearable sensor, and may detect the action of the worker.

The edge processing device 62 is a computer that generates three-dimensional information including a plurality of pieces of three-dimensional model data and a skeleton model of a person from the point group data acquired by the three-dimensional sensor 61. When the edge processing device 62 generates the three-dimensional information from the point group data, the amount of communication between the edge processing device 62 and the MEC server 40 can be reduced. It should be noted that, in a case where there is no problem with the amount of communication, the three-dimensional information may be generated after the point group data is transmitted as it is to the MEC server 40.

The administrator terminal 70 is a computer used by an administrator who is at the site and uses the information sharing system, and can display information (for example, a bird's-eye view image) of the virtual three-dimensional space 100.

The information sharing system of the present embodiment may have a cloud 90 that forms a large-scale virtual three-dimensional space for sharing the three-dimensional information collected from a plurality of MEC servers 40. The large-scale virtual three-dimensional space formed in the cloud 90 integrates the virtual three-dimensional spaces formed by the plurality of MEC servers 40, and a large-scale virtual three-dimensional space can be formed in a wide range.

It is preferable that access to the MEC servers 40 from the MR glasses 50, the VR glasses 60, and the administrator terminal 70 be authenticated by an ID and a password or by addresses (for example, MAC addresses) unique to these devices to ensure the security of the information sharing system.

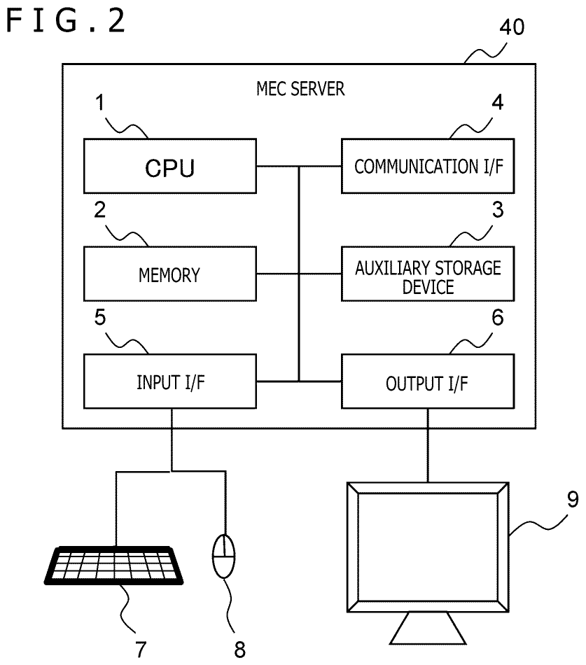

FIG. 2 is a block diagram for depicting a physical configuration of a computer provided in the information sharing system of the present embodiment. Although FIG. 2 depicts the MEC server 40 as an example of the computer, the edge processing devices 20 and 62 and the administrator terminal 70 may have the same configuration.

The MEC server 40 of the present embodiment includes a computer having a processor (CPU) 1, a memory 2, an auxiliary storage device 3, and a communication interface 4. The MEC server 40 may have an input interface 5 and an output interface 8.

The processor 1 is an arithmetic device for executing programs stored in the memory 2. Each functional unit (for example, a metaverse analysis function 400 or the like) of the MEC server 40 is realized by the processor 1 executing various programs. It should be noted that a part of the processing performed by the processor 1 executing the programs may be executed by another arithmetic device (for example, hardware such as a GPU, an ASIC, and an FPGA).

The memory 2 includes a ROM as a nonvolatile storage element and a RAM as a volatile storage element. The ROM stores an unchangeable program (for example, a BIOS) and the like. The RAM is a high-speed and volatile storage element such as a DRAM (Dynamic Random Access Memory), and temporarily stores a program to be executed by the processor 1 and data to be used when the program is executed.

The auxiliary storage device 3 is, for example, a large-capacity and nonvolatile storage device such as a magnetic storage device (HDD) or a flash memory (SSD). In addition, the auxiliary storage device 3 stores data to be used when the processor 1 executes programs and the programs to be executed by the processor 1. That is, the programs are read from the auxiliary storage device 3, loaded into the memory 2, and executed by the processor 1, to realize each function of the MEC server 40.

The communication interface 4 is a network interface device that controls communication with other devices (for example, the edge processing devices 20 and the cloud 90) according to a predetermined protocol.

The input interface 5 is an interface to which input devices such as a keyboard 6 and a mouse 7 are connected to receive an input from an operator. The output interface 8 is an interface to which output devices such as a display device 9 and a printer (not depicted) are connected to output the execution result of a program in a form that the user can visually recognize. It should be noted that a user terminal connected to the MEC server 40 via a network may provide an input device and an output device. In this case, the MEC server 40 has the function of a web server, and the user terminal may access the MEC server 40 by a predetermined protocol (for example, http).

The program executed by the processor 1 is provided to the MEC server 40 via a removable medium (a CD-ROM, a flash memory, or the like) or a network, and is stored in the nonvolatile auxiliary storage device 3 that is a non-transitory storage medium. Therefore, it is preferable that the MEC server 40 have an interface for reading data from a removable medium.

The MEC server 40 is a computer system configured on one physical computer or a plurality of logically or physically configured computers, and may operate on a virtual computer constructed on a plurality of physical computer resources. For example, each functional unit may operate on a separate physical or logical computer, or may operate on a single physical or logical computer obtained by combining a plurality of physical or logical computers.

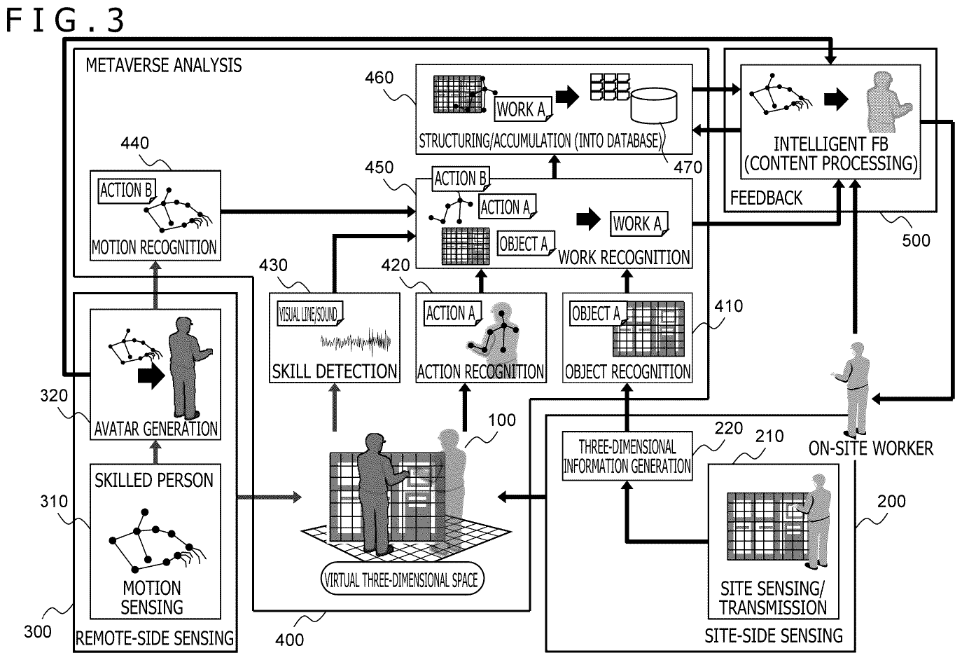

FIG. 3 is a logic block diagram of the information sharing system of the present embodiment.

The processing by the information sharing system of the present embodiment is executed by a site-side sensing function 200, a remote-side sensing function 300, a metaverse analysis function 400, and a feedback function 500.

In the site-side sensing function 200, the three-dimensional sensor 10 observes a situation at the site and transmits the observed point group data to the edge processing device 20 in site sensing/transmission processing 210. Then, in three-dimensional information generation processing 220, the edge processing device 20 generates three-dimensional information including the point group data and the three-dimensional model data observed by the three-dimensional sensor 10.

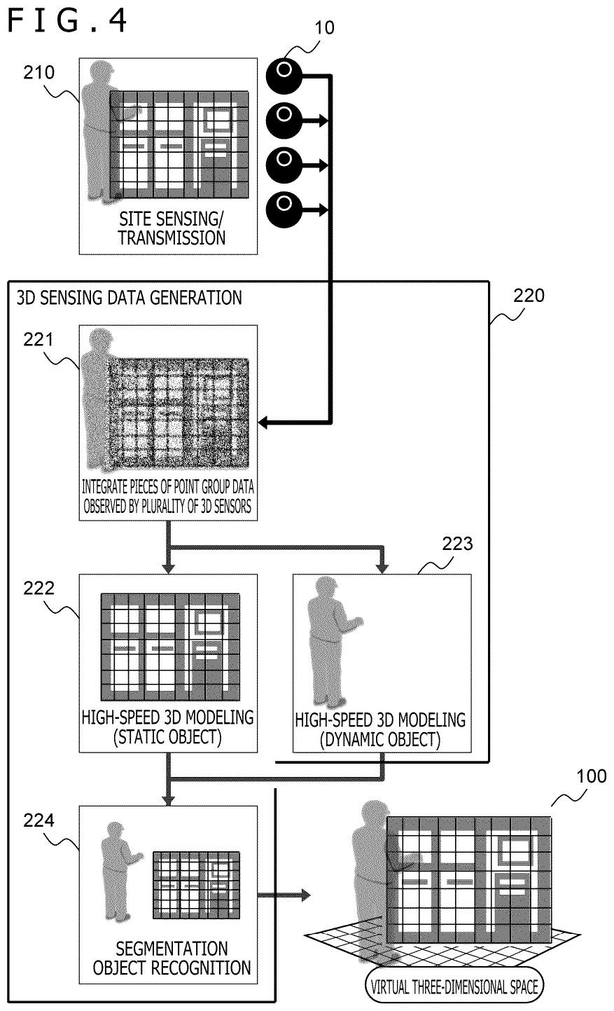

As the details of the site-side sensing function 200, as depicted in FIG. 4, the edge processing device 20 integrates the pieces of point group data observed by the plurality of three-dimensional sensors 10, on the basis of the relation between the positions and the observation directions of the plurality of three-dimensional sensors 10 (221). When the pieces of point group data are integrated, the video of the front of the wearer captured by the MR glasses 50 may be integrated.

Thereafter, static object high-speed three-dimensional modeling processing is executed (222). For example, an algorithm for generating surfaces on the basis of the positional relation between adjacent point groups can be used to configure the outer surface of a static object. In addition, dynamic object high-speed three-dimensional modeling processing is executed (223). For example, a range in which a shape or a position changes is extracted from the point group data, and a skeleton model obtained by skeleton estimation is generated to model a person. The generated skeleton model represents the position of the person (worker), and the time series change of the skeleton model represents the movement of the person. The modeling of the static object and the modeling of the dynamic object may be executed in order, and either may come first in the order.

Thereafter, the three-dimensional model is segmented by distinguishing the dynamic object from the static object and by determining the range that makes sense as an object according to the continuity of the configured surfaces and the range of the dynamic object (224).

In addition, the edge processing device 20 collects, from the MR glasses 50, the direction of the visual line of the wearer and the sound that the wearer is hearing, and transmits them to the MEC server 40. In the MEC server 40, the metaverse analysis function 400 to be described later recognizes a static object and a dynamic object to generate the virtual three-dimensional space 100.

In the remote-side sensing function 300, the three-dimensional sensor 61 observes a situation of the remote person and transmits the observed point group data to the edge processing device 62 in motion sensing processing 310. Then, the edge processing device 62 executes the dynamic object high-speed three-dimensional modeling processing on the point group data observed by the three-dimensional sensor 61 (310). For example, a range in which a shape or a position changes is extracted from the point group data, and a skeleton model obtained by skeleton estimation is generated to model a person. The generated skeleton model represents the position of the person (worker), and the time series change of the skeleton model represents the movement of the person.

Thereafter, the edge processing device 62 generates an avatar from the generated skeleton model (320). In addition, the edge processing device 62 collects, from the VR glasses 60, the direction of the visual line of the wearer and the sound that the wearer is hearing, and transmits them to the MEC server 40. The generated skeleton model is transmitted to the MEC server 40 and treated as an action B of the remote person. In addition, the generated avatar is transmitted to the MEC server 40 together with sound data that the wearer of the VR glasses 60 is hearing, and is incorporated into the virtual three-dimensional space 100 to be fed back to the MR glasses 50. The generated avatar may be fed back directly to the MR glasses 50. The wearer of the MR glasses 50 can share, with the remote person, the virtual three-dimensional space 100 in which actions and sensations represented by the movements and the positions of the remote person are incorporated, and can understand the movements of the remote person and have a conversation with the remote person.

In the metaverse analysis function 400, the MEC server 40 generates an avatar of the on-site worker from the skeleton model of the dynamic object recognized by the site-side sensing function 200, and generates an avatar of the remote person from the skeleton model of the remote person generated by the remote-side sensing function 300. The virtual three-dimensional space 100 is generated by mapping the generated avatars and the three-dimensional model data regarding the static object recognized by the site-side sensing function 200.

In object recognition processing 410, the MEC server 40 recognizes the segmented three-dimensional model and specifies an object. For example, the type of an object can be estimated by a machine learning model that has learned images of objects installed at the site or a model in which the three-dimensional shapes of objects installed at the site have been recorded.

In motion recognition processing 420, the MEC server 40 recognizes an action A (type of action) of the worker from the motion data including the movement and the position of the worker who is at the site, the movement and the position being represented by the skeleton model. For example, the action of the worker can be estimated by a machine learning model that has learned the motion data regarding changes in the skeleton model of the worker in the past and the action of the worker.

In skill sensing processing 430, the MEC server 40 detects the skill level of the worker by the direction of the visual line of the worker and the sound that the worker is hearing. For example, the skill level of the worker can be estimated by a machine learning model that has learned the direction of the visual line of the worker during work, the sound that the worker is hearing, and the skill level of the worker. In addition, the skill level of the worker may be estimated by comparing the work time of the worker with the standard work time. For example, in a case where the work time is smaller than the standard work time, it can be determined that the skill level is high.

In motion recognition processing 440, the MEC server 40 recognizes an action B (type of action) of the remote person from changes in the skeleton model of the remote person. For example, the action of the remote person can be estimated by a machine learning model that has learned changes in the skeleton model of the remote person in the past and the action of the remote person. The motion recognition processing 420 and the motion recognition processing 440 may use the same estimation model.

In work recognition processing 450, the MEC server 40 recognizes a work A of the worker from the object specified in the object recognition processing 410 and the action A of the worker recognized in the motion recognition processing 420. For example, the work A of the worker can be estimated by a machine learning model that has learned the object and the action A and by a knowledge graph associating an object with an action. Further, the work A of the worker may be recognized with use of the action B of the remote person recognized in the motion recognition processing 440.

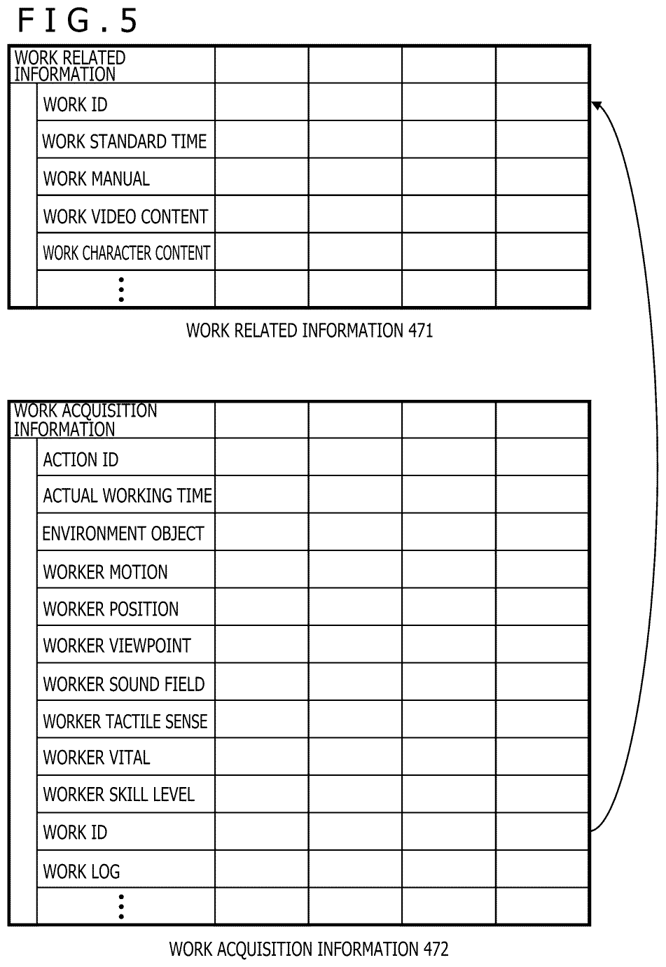

In structuring/accumulation processing 460, the MEC server 40 records, in a database 470, the work A recognized in the work recognition processing 450. In the database 470, the object used to recognize the work A, the action A, the motion data regarding changes in the skeleton model in the action A, the action B, and the motion data including the movement and the position of the worker at the site, the movement and the position being represented by the skeleton model in the action B, are registered as related information. A configuration example of the database 470 will be described in detail with reference to FIG. 5.

In the feedback function 500, the MEC server 40 retrieves the database 470 with the recognized action A of the worker as a key, and transmits feedback information acquired from the database 470 to the MR glasses 50. The information fed back to the MR glasses 50 is an avatar generated from the motion data regarding the same work of the same process performed previously, a video of the same work performed previously, and a work instruction of the next process of the work. In particular, it is preferable that, as the avatar and the work video, data regarding the same work performed by the remote person be provided. It is preferable that the information to be fed back to the MR glasses 50 be changed in accordance with the skill level estimated in the skill sensing processing 430 and the attribute of the worker. For example, it is preferable to provide detailed information to a low-skilled person and brief information to a high-skilled person. The feedback function 500 enables the worker wearing the MR glasses 50 to automatically acquire information related to his/her own action A.

The feedback function 500 may issue a command as feedback to facilities (for example, robots, construction machines, and vehicles) in addition to the feedback to the MR glasses 50. Accordingly, changes in the virtual three-dimensional space can be reflected in the real world, and various machines can be controlled.

FIG. 5 is a diagram for depicting a configuration example of the database 470 of the present embodiment. The database 470 is depicted in a table format in FIG. 5, but may be configured using other data structures.

The database 470 includes work related information 471 recorded in advance and work acquisition information 472 acquired with the action of the worker.

The work related information 471 stores a work ID, work standard time, a work manual, work video content, and work character content in association with each other. The work ID is identification information regarding the work recorded in advance. The work standard time is the standard time of the work performed by the worker. The work manual is an instruction for the work to be performed by the worker, and information regarding a link for accessing the instruction may be recorded. The work video content is a video of the work that is to be performed by the worker and has previously been performed by a skilled person or the worker, and information regarding a link for accessing the video may be recorded. The work character content is character information related to the work performed by the worker, and information regarding a link for accessing the character information may be recorded.

The work acquisition information 472 stores an action ID, actual work time, an environment object, a worker motion, a worker position, a worker viewpoint, a worker sound field, a worker tactile sense, a worker vital, a worker skill level, a work ID, and a work log in association with each other. The work ID is identification information regarding an action that is a series of motions of the worker. The actual work time is the time required for the action of the worker. The environment object is an object (for example, a room, a floor, a device, a tool, or a screw) imaged in relation to the action of the worker. The worker motion is the time change of the coordinates of the feature points (indirect points such as fingers and arms and the head) of the skeleton model of the worker. The worker position is the position of a feature point (the head, left and right hands, or the like) of the worker and a positional relation (a distance and a direction) with the environmental object. The worker viewpoint is the visual line of the worker and the intersection between the surface of an object present in the visual line direction and the visual line. The worker sound field is the sound that the worker is hearing, and information regarding a link for accessing the sound data may be recorded. The worker tactile sense is the tactile sense of the worker acquired by the tactile glove. The worker vital is the voice and facial expression of the worker, a pulse estimated from changes in blood flow, for example, and is used to estimate the emotions and attribute of the worker. The worker skill level is the skill level of the worker detected in the skill sensing processing 430. The work ID is the work of the worker recognized in the work recognition processing 450. The work log is the result of the execution of the work, and normal completion, rework, abnormal completion, or the like is recorded.

FIG. 6 is a diagram for depicting an example of a video fed back to the on-site worker and displayed on the MR glasses 50 in the information sharing system of the present embodiment.

As depicted in FIG. 6, the worker video is displayed such that VR glasses (the position of the head) 601 and hands 602 of the remote person are superimposed on the real scene. In FIG. 6, the avatar of the remote person is configured with the VR glasses and the hands, but an avatar representing the whole body of the remote person may be generated and displayed. Further, a worker attribute 611, a work manual 612, and a work instruction 613 may be displayed on the worker video. Further, an avatar (not depicted) generated from a skeleton model of another person present at the site may be displayed on the worker video.

The worker at the site can visually recognize the action of the remote person by means of the avatar on the worker video, and can receive appropriate guidance of the work from the skilled person who is in the remote place.

FIG. 7 is a diagram for depicting an example of a bird's-eye view image displayed on the administrator terminal 70 in the information sharing system of the present embodiment.

In the bird's-eye view image displayed on the administrator terminal 70, VR glasses (the position of the head) 701 and hands 702 of the skilled person in the remote place, an avatar 711 of the on-site worker, and an environmental object (work object) 721 are displayed by being superimposed on an image of a three-dimensional space.

The bird's-eye view image enables the administrator at the site to monitor the events in the virtual three-dimensional space, to check the guidance that the worker receives from the skilled person, and to manage the work of the worker.

It is preferable that the MEC server 40 adjust the range of the image such that the feedback video (FIG. 6) and the bird's-eye view image (FIG. 7) include only the video within a necessary range. The bird's-eye view image depicted in FIG. 7 is an example in which only the work object, the avatar of the worker, the avatar of the remote person, and the background around them are displayed and other backgrounds are eliminated. For example, it is preferable that, among the static objects and the dynamic objects recognized in the segmentation processing (224), the range of the image to be fed back be adjusted in a range that does not include objects unrelated to the work or mosaic processing be applied to a range that does not include objects unrelated to the work, to conceal objects unrelated to the work. When it is used at a site such as a factory, the leakage of information regarding the space of the factory and customers to the outside can be suppressed.

As described above, according to the embodiment of the present invention, the real-time situation at the site and the motions of a plurality of persons at a remote place can be shared in real-time, and appropriate guidance can be given to the site from the remote place.

It should be noted that the present invention is not limited to the above-described embodiment, and includes various modified examples and equivalent configurations within the scope of the appended claims. For example, the above-described embodiment has been described in detail for the purpose of clearly describing the present invention, and the present invention is not necessarily limited to those having all the configurations described. In addition, a part of a configuration of an embodiment may be replaced with a configuration of another embodiment. In addition, a configuration of an embodiment may be added to a configuration of another embodiment. In addition, a part of a configuration of each embodiment may be added, deleted, or replaced to/from/with another configuration.

In addition, some or all of the above-described configurations, functions, processing units, processing means, and the like may be realized by hardware by, for example, designing with an integrated circuit, or may be realized by software by a processor interpreting and executing a program for realizing each function.

Such information as programs, tables, and files that realize each function can be stored in a storage device such as a memory, a hard disk, or an SSD (Solid State Drive), or a recording medium such as an IC card, an SD card, or a DVD.

In addition, the control lines and information lines considered to be necessary for explanation are depicted, and all the control lines and information lines necessary for implementation are not necessarily depicted. In practice, almost all the configurations may be considered to be connected to each other.

1-16. (canceled)

17. A virtual three-dimensional space sharing system comprising:
a first display device that a first user can visually recognize at a first location;
a first sensor that observes an object which is a dynamic object at least one of a shape and a position of which is changed and the first user at the first location;
a second sensor that observes a movement of a second user at a second location different from the first location; and
a server that collects data from the first sensor and the second sensor,
wherein the server
maps the object and the first user observed by the first sensor and the second user observed by the second sensor to a virtual three-dimensional space, and
transmits information regarding the movement and a position of the second user relative to the object which is the dynamic object, the second user being mapped to the virtual three-dimensional space, to the first display device in real-time.

18. The virtual three-dimensional space sharing system according to claim 17,
wherein a second display device that the second user can visually recognize at the second location is provided, and
the server transmits information regarding the object and a movement and a position of the first user mapped to the virtual three-dimensional space to the second display device.

19. The virtual three-dimensional space sharing system according to claim 17,
wherein a third sensor that detects at least one of a sound, a visual line, and a tactile sense perceived by the first user is provided,
the third sensor transmits detected information to the server, and
the first sensor observes a movement of the first user.

20. The virtual three-dimensional space sharing system according to claim 17,
wherein a first edge device to which the first sensor is connected is provided,
the first sensor captures a video of the object installed at the first location, and
the first edge device transmits, to the server, difference data relative to a frame obtained at a time before a frame of the video of the object captured by the first sensor.

21. The virtual three-dimensional space sharing system according to claim 17,
wherein a first edge device to which the first sensor is connected is provided,
the first sensor acquires information regarding a movement and a position of the first user, and
the first edge device transmits, to the server, a skeleton model generated from the information regarding the movement and the position of the first user acquired by the first sensor.

22. The virtual three-dimensional space sharing system according to claim 17,
wherein a fourth sensor that detects at least one of a sound, a visual line, and a tactile sense perceived by the second user is provided, and
the fourth sensor transmits detected information to the server.

23. The virtual three-dimensional space sharing system according to claim 17,
wherein a second edge device to which the second sensor is connected is provided,
the second sensor captures a video of the object installed at the second location, and
the second edge device transmits, to the server, difference data relative to a frame obtained at a time before a frame of the video of the object captured by the second sensor.

24. The virtual three-dimensional space sharing system according to claim 17,
wherein a second edge device to which the second sensor is connected is provided,
the second sensor acquires information regarding the movement and the position of the second user, and
the second edge device transmits, to the server, a skeleton model generated from the information regarding the movement and the position of the second user acquired by the second sensor.

25. The virtual three-dimensional space sharing system according to claim 17,
wherein the server records, in a database, skeleton models generated from videos of the first user and the second user.

26. The virtual three-dimensional space sharing system according to claim 25,
wherein the server
recognizes the object from a result obtained by observation of the object by the first sensor,
specifies a work of the first user on a basis of a relation between the skeleton model generated from the video of the first user and the recognized object, and
records the specified work in the database.

27. The virtual three-dimensional space sharing system according to claim 17,
wherein a fifth sensor that detects at least one of a voice, a blood flow, and a facial expression perceived by the first user is provided, and
at least one of a skill level and an attribute of the first user is estimated from at least one of the voice, the blood flow, and the facial expression detected by the fifth sensor.

28. The virtual three-dimensional space sharing system according to claim 27,
wherein the server changes the information to be transmitted to the first display device, according to at least one of the estimated skill level and attribute.

29. The virtual three-dimensional space sharing system according to claim 26,
wherein the server
acquires information related to the specified work from the database, and
transmits the information acquired from the database to the first display device.

30. The virtual three-dimensional space sharing system according to claim 17,
wherein a terminal connected to the server is provided, and
the server transmits, to the terminal, data regarding the virtual three-dimensional space to which the object, the first user, and the second user are mapped.

31. A virtual three-dimensional space sharing method executed by a computer,
wherein the computer
has an arithmetic device for executing predetermined arithmetic processing and a storage device accessible by the arithmetic device, and
is connected to a first display device that a first user can visually recognize at a first location, a first sensor installed at the first location, and a second sensor installed at a second location different from the first location,
in the virtual three-dimensional space sharing method,
the arithmetic device collects data regarding an object which is a dynamic object at least one of a shape and a position of which is changed and the first user observed by the first sensor at the first location and data regarding a second user observed by the second sensor at the second location,
the arithmetic device maps the object and the first user observed by the first sensor and the second user observed by the second sensor to a virtual three-dimensional space, and
the arithmetic device transmits, to the first display device in real-time, information regarding a movement and a position of the second user relative to the object which is the dynamic object, the second user being mapped to the virtual three-dimensional space.

32. A virtual three-dimensional space sharing server,
wherein an arithmetic device for executing predetermined arithmetic processing and a storage device accessible by the arithmetic device are provided,
the virtual three-dimensional space sharing server is connected to a first display device that a first user can visually recognize at a first location, a first sensor installed at the first location, and a second sensor installed at a second location different from the first location,
data regarding an object which is a dynamic object at least one of a shape and a position of which is changed and the first user observed by the first sensor at the first location and data regarding a second user observed by the second sensor at the second location are collected,
the object and the first user observed by the first sensor and the second user observed by the second sensor are mapped to a virtual three-dimensional space, and
information regarding a movement and a position of the second user relative to the object which is the dynamic object, the second user being mapped to the virtual three-dimensional space, is transmitted to the first display device in real-time.
